(19) United States
(12) Patent Application Publication
(10) Pub. No.: US 2024/0353549 A1
(43) Pub. Date: Oct. 24, 2024

(54) CIRCUIT APPARATUS FOR LOCATING AT LEAST ONE DEVICE UNIT IN A PARTICULAR LOCATING SESSION, METHOD AND VEHICLE

(71) Applicant: Continental Automotive Technologies GmbH, Hannover (DE)

(72) Inventors: Thomas Reisinger, Regenstauf (DE); Constantin Papandonatos, Regensburg (DE)

(73) Assignee: Continental Automotive Technologies GmbH, Hannover (DE)

(21) Appl. No.: 18/682,887

(22) PCT Filed: Jul. 7, 2022
(86) PCT No.: PCT/DE2022/200151

§ 371 Date: Feb. 9, 2024

(30) Foreign Application Priority Data
Aug. 10, 2021 (DE) 10 2021 208 719.1

(51) Int. Cl. G01S 13/02; B60R 25/24; G07C 9/00; H04W 4/40; H04W 4/80

(52) U.S. Cl. CPC G01S 13/0209; B60R 25/24; G07C 9/00309; H04W 4/40; H04W 4/80; G07C 2209/63

(57) ABSTRACT

A circuit apparatus for locating a device unit in a respective locating session communicating bidirectionally with the device unit via ultra-wide-band radio in a predetermined common frequency band, comprises a control unit configured to control a transceiver unit of the circuit apparatus to emit a respective locating signal to the respective device unit in successive time blocks of a predetermined time grid of the locating session. The circuit apparatus comprises a monitoring unit configured to check, before the respective transmission of a locating signal to be transmitted, whether a predetermined transmission condition specifying a maximum permissible degree of utilization for the frequency band is fulfilled by the transmission of the locating signal to be transmitted, to enable the emission of the locating signal to be transmitted if the transmission condition is fulfilled, and otherwise to block the emission of the locating signal to be transmitted.

### DESCRIPTION

In order to enable contactless unlocking of a vehicle, it is common to provide device units such as radio keys or smartphones, for example, which can communicate with a transceiver unit of a vehicle via ultra-wide-broadband radio, UWB, in a predetermined frequency band. Provision is made here for the vehicle to be unlocked when the device unit is in a predetermined range with respect to the vehicle. A position of the device unit is determined in this case during a locating session. During a locating session, the respective device unit and the respective circuit apparatus exchange locating signals. It is possible to determine a position of the device unit by trilateration over a propagation time of the locating signals. As the number of device units communicating with the circuit apparatus increases, so does the number of locating signals to be exchanged. Due to the increase in the exchanged locating signals, a transmission time slice, which describes a ratio between the phases with and without transmission, increases. In order to avoid overloading the frequency band, legal requirements which limit a transmission time slice and/or a number of locating signals have been developed.

However, in the case of a large number of device units, a locating apparatus may exceed the permissible limit. When monitoring a small future range, the problem arises that the time of a transmission is determined pseudo-randomly by the respective device unit and cannot be influenced by the locating apparatus. The transmissions for multiple device units accumulate in a locating apparatus in a random, uncoordinated manner.

For example, a limit on the transmission time slice is described in Commission Implementing Decision (EU) 2019/785 on the harmonization of radio spectrum for equipment using ultra-wideband technology in the Union and repealing Decision 2007/131/EC.

One object of the invention is to render possible compliance with utilization of a frequency band.

A first aspect of the invention relates to a circuit apparatus for locating at least one device unit in a respective locating session. The circuit apparatus may be, for example, an apparatus for emitting and receiving locating signals according to the UWB standard. The circuit apparatus may be configured to unlock or lock a vehicle depending on a specific position of the device unit. The device unit may be, for example, a radio key or a smartphone configured to transmit and/or receive locating signals via radio via UWB. The device unit may be coupled to the circuit apparatus. For example, the locating session may be a so-called ranging session, which can run according to a predetermined protocol. Provision may be made, in the respective locating session, for the circuit apparatus on the one hand and the at least one device unit on the other hand to communicate with one another via ultra-wide-band radio in a predetermined common frequency band. The communication may comprise an exchange of the locating signals, wherein the locating signals may have time-stamp signals of a reception or an emission of the respective time signal, in order to be able to determine a distance between the device unit and the circuit apparatus over a propagation time. The circuit apparatus comprises a control unit which is configured to control a transceiver unit of the circuit apparatus in order to emit a respective locating signal to the respective device unit in successive time blocks of a predetermined time grid of the locating session. In other words, the circuit apparatus comprises the control unit, which may be a unit for controlling at least one transceiver unit. The control unit may have a microprocessor or a microcontroller. The control unit is configured to control the transceiver unit in order to emit the locating signals to the respective device unit in successive time blocks of the predetermined time grid of the locating session.

Provision is made for the circuit apparatus to have a monitoring unit which is configured to check, before the respective transmission of a locating signal to be transmitted, whether a predetermined transmission condition specifying a maximum degree of utilization for the frequency band is fulfilled by the transmission of the locating signal to be transmitted. In other words, provision is made for the monitoring unit to be configured to check whether the predetermined transmission condition specifying a maximum degree of utilization for the frequency band is fulfilled if the locating signal to be transmitted is transmitted by the transceiver unit. The predetermined transmission condition in this case describes a maximum degree of utilization for the frequency band. In other words, the monitoring unit is configured to check whether a utilization of the frequency band is exceeded. Provision is made for the monitoring unit to be configured to enable the emission of the locating signal to be transmitted if the transmission condition is fulfilled. In other words, provision is made for the monitoring unit to be configured to enable the transmission of the locating signal requested by way of the control unit if the transmission condition is met by the transmission process. Provision is made for the monitoring unit to be configured to block the emission of the locating signal to be transmitted if the transmission condition is not fulfilled in the case of transmission of the locating signal to be transmitted. In other words, the monitoring unit is configured to block the emission of the locating signal if this would result in a violation of the transmission condition. This can ensure that the transmission conditions in terms of frequency band utilization are met. Coordination or planning of the emission of the locating signal therefore does not have to be planned by the control unit in the long term, but is continuously monitored by the monitoring unit.

The invention also includes developments that result in further advantages.

One development of the invention makes provision for the monitoring unit to be configured to record a number of transmitted locating signals in a predetermined first time interval, and for the transmission condition to comprise a transmission criterion which specifies that the transmission of the locating signal currently to be transmitted is enabled only if a permissible maximum number of transmissions of locating signals is undershot when the locating signal to be transmitted is transmitted in the first predetermined time interval. In other words, the monitoring unit is configured to monitor a number of transmitted locating signals in the first time interval. Provision is made here for the monitoring unit to be configured to record how many locating signals have already been transmitted in the first time interval. If a further locating signal is to be transmitted, the monitoring unit is used to check whether transmitting the locating signal to be transmitted would exceed a permissible maximum number of locating signals in the predetermined first time interval. This allows the monitoring unit to monitor that the permissible number of transmitted locating signals is not exceeded.

One development of the invention makes provision for the monitoring unit to be configured to record an accumulated duration of pulse times of the already transmitted locating signals in a predetermined second time interval, and for the transmission condition to comprise a transmission criterion which specifies that the transmission of the locating signal to be transmitted is enabled only if a permissible maximum accumulated duration of the locating signals is undershot when the locating signal to be transmitted is transmitted in the second predetermined time interval. In other words, the monitoring unit is configured to ensure compliance with a maximum accumulated duration of the locating signals in the second predetermined time interval. The monitoring unit is configured to detect how long the pulse time of the transmitted locating signals is in the predetermined second time interval. The locating signal to be transmitted is in this case enabled by the monitoring unit only if the permissible maximum accumulated duration of the locating signals in the second predetermined time interval is undershot. In other words, an emission of the locating signal to be transmitted is enabled only if this does not exceed the maximum permissible accumulated duration of the locating signals.

One development of the invention makes provision for at least one of the transmission criteria to depend on a priority value of the locating signal to be transmitted. In other words, provision is made for a locating signal to be assigned a predetermined priority value based on a content of the locating signal or an addressee of the locating signal, said priority value being provided for determining a priority of the locating signal to be transmitted in comparison with other ones of the locating signals. Provision may be made, for example, for a locating signal which is associated with a first of the device units to be assigned a higher priority value than a locating signal which is associated with a second of the device units. This may be provided for the case that the locating signal with the higher priority value is preferred in case of a conflict over emitting a locating signal with a lower priority value. The prioritization can be implemented here by a maximum number and/or the maximum accumulated duration differing depending on the priority value of the locating signal to be transmitted. This has the advantage that it is possible to take into account the fact that some locating signals are more important than others. Depending on the priority value of the locating signal, the respective maximum number and/or the maximum accumulated duration may have different values for different locating signals or their receiver, which may be the device unit.

One development of the invention makes provision for the monitoring unit to be configured to determine a time-stamp signal, which signals a reception time of the respective transmitted locating signal by the device unit. Provision may be made for the monitoring unit to be configured to record only those transmitted locating signals whose time-stamp signal is present. In other words, provision is made for the monitoring unit and/or the device unit to be able to generate a time-stamp signal that can describe a reception time of the locating signal. When monitoring the compliance with the transmission criteria, provision may be made for only those transmitted locating signals whose time-stamp signal is present to be recorded and thus taken into account. The time-stamp signals may be provided by the transceiver unit and/or the control unit and/or the device unit. This can ensure that locating signals that have not been received are not taken into account in the compliance with the criteria.

One development of the invention makes provision for at least one of the transmission criteria to depend on a number of currently simultaneously running locating sessions. In other words, the monitoring unit is configured to adjust the transmission criteria depending on a number of currently simultaneously running locating sessions. For example, provision may be made, in the case of a single currently running locating session, for greater maximum values with regard to the locating signals to be emitted to be granted than in the case of several simultaneously running locating sessions.

One development of the invention makes provision for the respective time intervals to be timer-based and/or based on a sliding window algorithm and/or a ring buffer. In other words, a moving window is monitored by the monitoring unit.

One development of the invention makes provision for the time grid to be set on the basis of a random function or pseudo-random function for emitting the locating signals. In other words, the locating signals are emitted depending on a random function or pseudo-random function stored in the control unit. Provision may be made, for example, for the time grid not to specify a constant value for the output of the locating signal but a point in time that is specified by means of a random function or pseudo-random function stored in the control unit and/or the device unit.

One development of the invention makes provision for the monitoring unit to be configured, after at least one blocking, to reserve a priority for locating signals to that device unit for which the transmission of the locating signal was blocked, and to take this into account when checking the transmission condition. In other words, provision is made for the locating signals that are blocked to be prioritized in a next transmission. This results in the advantage that a failure to emit results in a preferred emission in a next process step, which can prevent prolonged suspension of locating of a device unit.

A second aspect of the invention relates to a method for operating a circuit apparatus for locating at least one device unit in a respective locating session. Provision is made, in the respective locating session, for the circuit apparatus on the one hand and the at least one device unit on the other hand to communicate with one another via ultra-wide-band radio in a predetermined common frequency band. Provision is made for a control unit of the circuit apparatus to be used to control a transceiver unit of the circuit apparatus in order to emit a respective locating signal to the respective device unit in successive time blocks of a predetermined time grid of the locating session. A monitoring unit of the circuit apparatus is used to check, before the respective transmission of a locating signal to be transmitted, whether a predetermined transmission condition used to specify a maximum degree of utilization for the frequency band is fulfilled by the transmission of the locating signal to be transmitted. Provision is made for the emission of the locating signal to be transmitted to be enabled by the monitoring unit if the transmission condition is fulfilled, and otherwise the emission of the locating signal to be transmitted to be blocked by the monitoring unit.

A third aspect of the invention relates to a vehicle which comprises a circuit apparatus according to any one of the preceding claims.

The invention also includes developments of the method according to the invention having features as have already been described in connection with the developments of the vehicle according to the invention. For this reason, the corresponding developments of the method according to the invention are not described here again.

The invention also encompasses the combinations of the features of the embodiments described.

An exemplary embodiment of the invention is described below, in which regard:

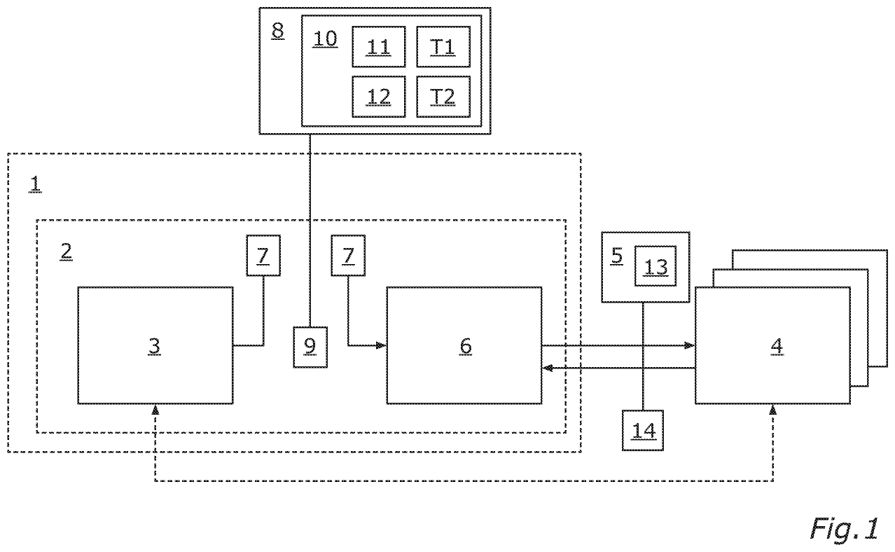

FIG. 1 shows a schematic illustration of a sequence of a method for operating a circuit apparatus for locating at least one device unit in a respective locating session;

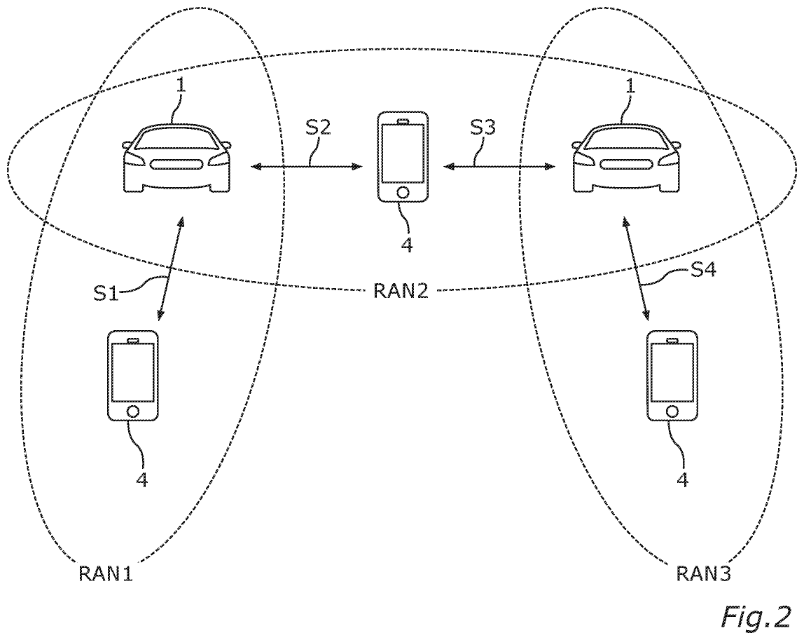

FIG. 2 shows a schematic illustration of predetermined locating sessions between the circuit apparatuses of vehicles and device units;

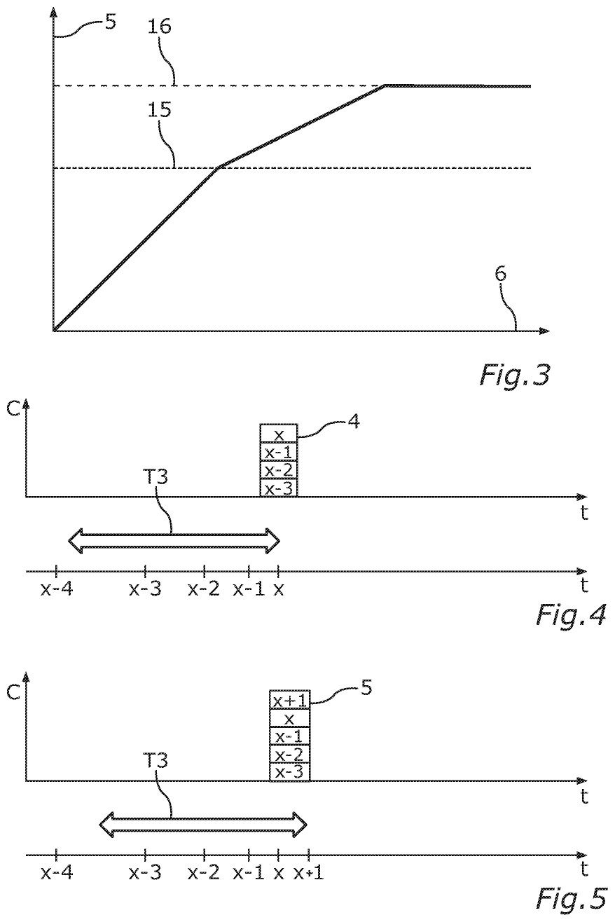

FIG. 3 shows a schematic illustration of a possible number of emitted locating signals;

FIG. 4 shows a schematic illustration of a monitoring process of the locating signals to be emitted;

FIG. 5 shows a schematic illustration of a blocking process of an emission of a locating signal to be transmitted x+1;

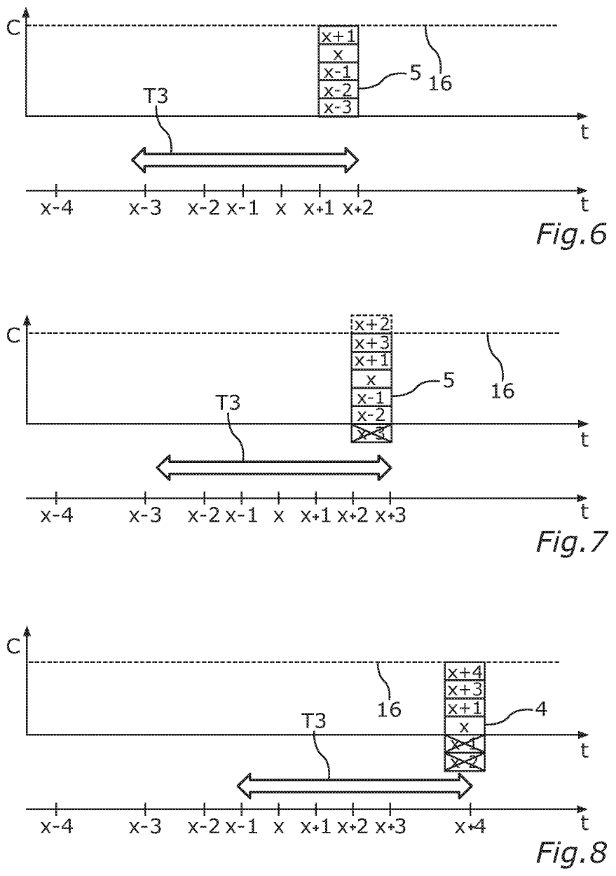

FIG. 6 shows a schematic illustration of a blocking process of an emission of a locating signal to be transmitted x+2;

FIG. 7 shows a schematic illustration of a distance of a recorded emitted locating signal from the queue of the monitoring unit;

FIG. 8 shows a schematic illustration of the queue in the case of two of the recorded locating signals being deleted;

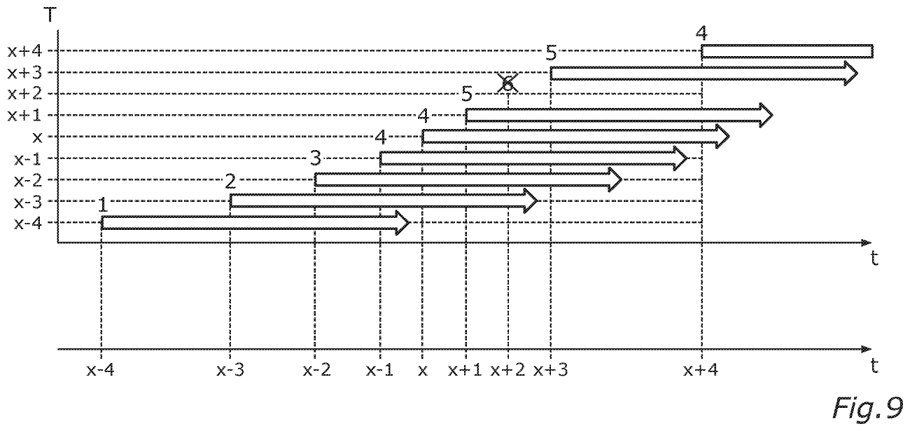

FIG. 9 shows a schematic illustration of a timer-based embodiment; and

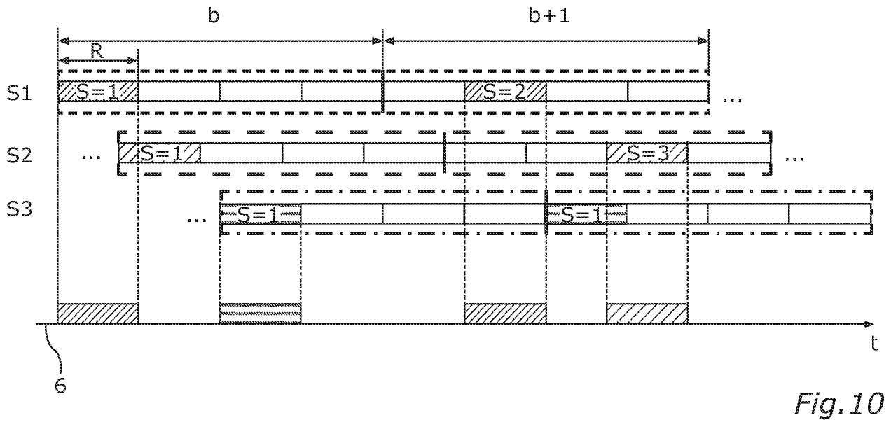

FIG. 10 shows a schematic illustration of a profile of three currently running locating sessions with respective device units with the circuit apparatus.

The exemplary embodiment explained below is a preferred embodiment of the invention. In the exemplary embodiment, the described components of the embodiment each represent individual features of the invention that should be considered independently of one another and that each also develop the invention independently of one another and can therefore also be considered to be part of the invention individually or in a combination other than that shown. Furthermore, the embodiment described may also be supplemented by further features of the invention that have already been described.

In the figures, elements with the same function are each provided with the same reference signs.

FIG. 1 shows a schematic illustration of a sequence of a method for operating a circuit apparatus 2 for locating at least one device unit 4 in a respective locating session. Provision may be made, in a vehicle 1, for the circuit apparatus 2 to be arranged to enable a UWB locating method. The circuit apparatus 2 may comprise a control unit 3 which may be a microprocessor or a microcontroller. The control unit 3 may be provided to determine a position of a device unit 4 in a particular locating session. The device unit 4 may be, for example, a radio key and/or a smartphone configured to carry out the locating method. The control unit 3 may be configured to negotiate parameters of the protocol with the device unit 4 in order to carry out the locating method. The device unit 4 can be located by emitting locating signals 5. In order to emit the locating signals 5, the circuit apparatus 2 may have one or more transceiver units 6. The transceiver units 6 may be arranged at different positions of the vehicle 1, as a result of which location of the device unit 4 can be made possible by means of a trilateration method.

During the locating method, a distance between the transceiver unit 6 and the device unit 4 can be determined by means of determining the propagation time of the locating signal 5. For the purpose of emitting the locating signal 5, a control signal 7 can be emitted to the transceiver unit 6 by the control unit 3. The control unit 3 and the transceiver unit 6 may be two separate devices that can be connected by a bus, for example a CAN bus. The control unit 3 can instantiate a locating session on the transceiver unit 6 by emitting the session context (session ID, session parameters) to the transceiver unit 6. The conduction of the locating session, that is to say including the periodic emission of the locating signals, can be carried out autonomously by the transceiver unit 6. The times of the emission can be set by a time grid coupled to a locating session. This time grid can be started and controlled by the device unit. The time grid can be predefined with the start for the entire locating session so there is no possibility of coordination or planning for the transceiver unit 6 or for the control unit 3 in the vehicle 1. The emission of the locating signal is not usually controlled by the control unit. When conducting the locating session, the problem may arise that predetermined transmission criteria 10 of a transmission condition 8 which concerns the common frequency band must be complied with. The transmission condition 8 may comprise several of the transmission criteria 10 and be stored in a monitoring unit 9 which may be configured to monitor the compliance with these transmission criteria 10. Provision may be made here for the monitoring unit 9 to be connected between the control unit 3 and the transceiver unit 6 and to receive the control signals 7. The monitoring unit 9 may be a constituent part of the transceiver unit 6. In other words, the transceiver unit 6 may comprise the monitoring unit 9. The monitoring unit 9 can record the number of emitted locating signals 5 transmitted in a predetermined first time interval T1. A first of the transmission criteria 10 can specify that a predetermined maximum number of permissible locating signals 5 during the first time interval T1 may not be exceeded. Based on the recording of the emitted locating signals 5, the monitoring unit 9 can determine whether the maximum number would be exceeded by emitting the locating signal 5 to be emitted.

If this is the case, provision may be made for the forwarding of the control signal 7 to be amplified by the monitoring unit 9, as a result of which the locating signal 5 is not emitted by the transceiver unit 6. If the check reveals that the transmission condition 10 is fulfilled, forwarding of the control signal 7 to the transceiver unit 6 and thus emission of the locating signal 5 to be transmitted can be permitted. The transmission condition 10 may also prescribe that an accumulated duration of emission times of the already transmitted locating signals 5 in a second time interval T2 may not exceed a predetermined permissible accumulated duration of the locating signals 5. Provision may be made for the control signal 7 not to be forwarded by the monitoring unit 9 in the case of an exceedance. If the transmission condition 10 is fulfilled, the control signal 7 can be forwarded to the transceiver unit 6, as a result of which the locating signal 5 to be transmitted is transmitted. Provision may be made for the locating signals 5 to be assigned a priority value 13 that can describe an urgency of an emission. For example, the priority value 13 may depend on a type of the device unit 4. The priority value 13 can describe which transmission criteria 10 are present for which of the locating signals 5. Provision may be made, for example, for the transmission criteria 10 to depend on the priority value 13 of the locating signal 5 to be transmitted. For example, the permissible maximum number and/or the permissible maximum accumulated duration of the locating signals 5 may depend on the priority value 13. Provision may be made for the monitoring of the transmission condition 10 to involve recording only those emitted locating signals 5 for which a time-stamp signal 14 has been generated. The time-stamp signal 14 can be transmitted, for example, by the device unit 4 to the transceiver unit 6 and confirm reception of the associated locating signal 5. Provision may be made for the transmission criteria 10 to be dependent on a number of locating sessions that are running at one time. Emission times of the locating signals 5 during the locating session may depend on a random generator or a pseudo-random function. In the event that emission of the locating signal 5 to be emitted is blocked by the monitoring unit 9, provision may be made, for the corresponding device unit 4 or for the corresponding locating signal 5 to be emitted, for a process which can lead to the relevant locating signal 5 being prioritized in a next emission round to be stored in the monitoring unit 9.

FIG. 2 shows a schematic illustration of predetermined locating sessions between the circuit apparatuses 2 of vehicles 1 having device units 4. A locating session between a device unit 4 and a circuit apparatus 2 of a vehicle 1 is referred to as a “ranging session”. A particular device unit 4 may have only one locating session with a particular vehicle 1 at a time in each case.

However, a vehicle 1 may simultaneously have several locating sessions with different device units 4 and vice versa for the device, as illustrated in FIG. 2.

FIG. 3 shows a schematic illustration of a possible number of emitted locating signals 5 per second plotted against the number of packets to be emitted per second requested by the control unit 3. Provision may be made, up to a certain number of locating signals 5 to be transmitted, for all of the locating signals 5 to be enabled by the monitoring unit 9 because the transmission condition 10 is fulfilled. Provision may be made, from a certain number, for a maximum number of permissible locating signals 5 in the first time interval T1 for packets of a lower priority 15 to be exceeded and for an emission of locating signals 5 of a lower priority 15 to be reduced or completely blocked. Provision may be made, from a further threshold value 16, for all packets which are to be transmitted as locating signals 5 to be blocked over a certain number.

FIG. 4 shows a schematic illustration of a monitoring process of the locating signals 5 to be emitted by the monitoring unit 9 according to a buffer storage method. This can be implemented on the basis of a sliding window algorithm and/or a use of the buffer as a ring buffer. Provision may be made for time-stamp signals 14 of all emitted locating signals 5 in the first time interval T1 to be stored. As soon as a new emission of a locating signal 5 to be transmitted is planned, a time-stamp signal 14 assigned to the locating signal 5 to be transmitted can be associated with a queue. Provision may be made for previous time-stamp signals 14 of already emitted locating signals 5 to be removed in this case. A number of the time-stamp signals 14 in the queue can be used as a counter in this case. In the event that the counter exceeds a predetermined threshold value 16, the emission of a locating signal 5 to be emitted can be blocked. Provision may be made for the buffer memory to be read out by the monitoring unit 9 before enabling a locating signal 5 to be transmitted. In this case, the buffer memory can be checked for the presence of time-stamp signals 14 that fulfill a criterion of “less than the planned transmission time minus 1 second”. In other words, the monitoring unit 9 is configured to determine the presence of the time-stamp signal 14 which records successful transmission of the respective locating signal 5, which was transmitted at most one second ago. The one second may in this case be the first and/or the second predetermined time interval T1.

The monitoring unit 9 can be provided for deleting older time-stamp signals 14 from the buffer memory when these are no longer required. This may be the case when the time of transmitting the respective locating signal 5, which may be described in the time-stamp signal 14, is outside the first and/or the second time interval T1. Provision may thus be made for a number of time-stamp signals 14 in the first and/or second time interval T1, which can be stored in the buffer memory, to be counted by the monitoring unit 9 before enabling a locating signal 5 to be transmitted. If the transmission of the locating signal 5 to be transmitted would lead to the predetermined threshold value 16 being exceeded, the planned transmission of the locating signal 5 to be transmitted is blocked by the monitoring unit 9. Otherwise, the transmission of the locating signal 5 to be transmitted is enabled. In this case, the respective time-stamp signal 14 for the locating signal 5 to be transmitted can be stored in the buffer memory by the monitoring unit 9. The time-stamp signal 14 can be stored when the locating signal 5 to be transmitted is transmitted and/or when a time-stamp signal 14 associated with the locating signal 5 is received by the transceiver unit. The time-stamp signal 14 can be transmitted by the device unit 4 which has received the locating signal 5 and confirms the reception by transmitting the time-stamp signal 14.

FIG. 5 shows a schematic illustration of a blocking process of an emission of a locating signal 5 to be transmitted x+2. The locating signal 5 to be transmitted would cause the predetermined threshold value 16 to be exceeded. Consequently, the control signal 7 is not forwarded to the transceiver unit 6 by the monitoring unit 9.

FIG. 6 shows a schematic illustration of a distance of a recorded emitted locating signal 5 from the queue of the monitoring unit 9. It is possible that the emitted locating signal 5 x−lies outside the time interval T1 and is thus deleted from the queue because the time window has extended further. As a result of the fact that the emitted locating signal 5 is outside the time window, a place in the queue becomes free and a locating signal 5 to be transmitted does not exceed the threshold value 16, with the result that this can be enabled by the monitoring unit 9.

FIG. 7 shows a schematic illustration of the queue in the case of two of the recorded locating signals 5 being deleted. It may be that the locating signals 5 are outside the time interval T1 and therefore no longer need to be observed.

FIG. 8 shows a schematic illustration of a timer-based embodiment. Provision may be made for a timer for a predetermined time interval T1 to be started when a locating signal 5 5 is emitted. Provision can be made for the monitoring unit 9 to monitor the number of current timers and not to activate a signal until a number of active timers is undershot. Another embodiment may include a transmission counter with running timers which are able to be monitored by the monitoring unit 9. For each successful transfer and/or transmission, a timer with a predetermined expiry time, which may be, for example, 1 second, can be started by the monitoring unit 9. When the locating signal 5 to be transmitted is to be transmitted, the number of timers that have not expired can be counted by the monitoring unit 9. More precisely, the monitoring unit 9 can be used to count a number of timers that would not have expired at a planned time of emitting the locating signal 5 to be emitted. If the transmission of the locating signal 5 to be transmitted would lead to the threshold value 16 being exceeded, the transmission of the locating signal 5 to be transmitted can be blocked by the monitoring unit 9. Otherwise, the planned transmission can be enabled by the monitoring unit 9. An additional timer can be started at the time when the scheduled transmission and/or transfer is complete.

FIG. 9 shows a schematic illustration of a profile of three currently running locating sessions with respective device units 4 with the circuit apparatus 2. The length Tblock of a ranging block is a multiple of 96 ms. A block length could last 3*96 ms=288 ms. Each block can be divided into one or more ranging rounds, with only one of the ranging rounds actually being used for the ranging exchange between the device and the vehicle 1. This “active” ranging round is determined by a pseudo-random jump sequence known to the device and the vehicle 1. This means that exactly one ranging exchange takes place per ranging block. Therefore, the length of the distance measurement block can also be considered an update period for the ranging. FIG. 9 depicted shows an example with three current locating sessions, all of which use a block of 4 ranging rounds. “TRX” shows the resource allocation on the transceiver level of the vehicle 1/the circuit apparatus 2.

The circuit apparatus 2 can block transmissions of locating signals 5 to be emitted, which is also referred to as muting, autonomous deviation from the protocol/the specification, if the protocol would violate transmission condition 10, which specifies a maximum degree of utilization for the frequency band. For example, a violation could occur if a permissible emission time slice is exceeded. Monitoring of compliance could be performed by a monitoring unit 9. The monitoring unit 9 can thus act as a “duty-cycle limiter”, as so-called transmission time slice limiter. The monitoring unit 9 can monitor a number of transmitted locating signals 5 in a predetermined first time interval T1 and/or monitor an accumulated duration of the locating signals 5.

A number of transmissions of locating signals 5 per second or another first time interval T1. The monitoring unit 9 may be configured the cumulative switched-on duration of the locating signals 5 within 10 seconds or a second time interval T1 with a different duration.

The monitoring unit 9 can mute a scheduled transmission, for example if a predefined threshold value 16 for one of the monitored parameters is exceeded. In this case, the transmission condition 10 may specify that the predefined threshold values 16 may not be exceeded by transmitting a locating signal 5 to be transmitted.

Provision may be made, for example, for a transmission of a locating signal 5 to be transmitted to be blocked by the monitoring unit 9 if a number of transmissions per second would thus exceed a predefined threshold value 16 of 26 locating signals 5 per second.

Provision may be made, for example, for a transmission of a locating signal 5 to be transmitted to be blocked by the monitoring unit 9 if a cumulative switched-on duration would thus exceed a predefined threshold value 16 of 50 msec within 10 seconds.

For each of the transmission criteria, different threshold values 16 can be defined, for example depending on a type of the locating signals 5, in order to take different packet sizes of the respective locating signals 5 into account. Different priority values 13 can be assigned to the locating signals 5 for this purpose. Provision may be made, for example, to set lower threshold values 16 for locating signals 5 of a low priority value 13 and higher threshold values 16 for locating signals 5 of a higher priority value 13. This can ensure that, at a greater utilization of the frequency band, for example first the transmission of locating signals 5 of a low priority value 13 is blocked before locating signals 5 of a higher priority value 13 are blocked.

A first low threshold value 16 may be provided here for packets with a low priority value 13. A second higher or maximum threshold value 16 may be provided for packets with a high priority value 13. Additional priority levels and corresponding threshold values 16 may be provided to fine-tune the margin of different package categories. Lower threshold values 16 can be set dynamically, taking into account the transmission history, a total number of currently active locating sessions, or any other measures of frequency band utilization.

A dynamic adjustment of the threshold values 16 may be provided to avoid unnecessary limits on packets with a low priority 15 if utilization levels for the frequency band are not yet exceeded by the locating signals 5. The packet priority 15 of the locating signal 5 can be assigned by the control unit 3 and/or the transceiver unit or can be inherited/modeled by higher packets.

The locating signal 5 from different locating sessions can inherit the session priority 15. Locating signals 5 of vehicle-internal locating sessions, which are not involved in the communication with the device unit 4, may be assigned a lower priority value 13 in order to be able to provide more room for packets of the actual locating session with the device units 4. So-called internal locating sessions, which can be carried out, for example, between the transceiver units of the circuit apparatus 2, may include an exchange of locating signals 5 for the transmission of synchronization data and/or transmission parameters between the transceiver units.

Monitoring by way of the monitoring unit 9 can be performed in different ways. One possible embodiment may provide that the monitoring unit 9 counts the transmitted locating signals 5 by means of a transmission counter which may have a buffer memory.

In this case, transmitted locating signals 5, for which a respective time-stamp signal 14 is present, can be recorded in the buffer memory. The time-stamp signal 14 can be used to ensure that a successful transmission of the locating signal 5, for example from the transceiver unit to the device unit 4, has taken place. The monitoring unit 9 can thus be a so-called transmission counter, which can record successful transmissions.

Another embodiment may monitor an accumulated duration of the locating signals 5 via the buffer memory. Time-stamp signals 14 of successful transmissions can be collected in the buffer memory, which in this case may be a “transmission counter”. The respective duration of the transmitted locating signal 5 can be recorded in the time-stamp signals 14 as “on-time”. If a transmission of the locating signal 5 to be transmitted is planned, the buffer memory can be searched by the monitoring unit 9 for time-stamp signals 14 meeting the criterion “smaller than the planned transmission time minus 10 seconds”. In other words, the time-stamp signals 14 are read out, by means of which a transmission of respective locating signals 5 is recorded in a period of 10 seconds before the planned transmission time of the locating signal 5 to be transmitted. The older time-stamp signals 14 can be removed from the buffer memory when they are no longer needed. A switched-on duration of all of the locating signals 5 stored by the time-stamp signals 14 in the buffer memory can be referred to as “cumulated on-time” accumulated duration of the locating signals 5. The duration of the locating signal 5 to be transmitted can be added by the monitoring unit 9 to the accumulated duration of the already transmitted locating signals 5. This results in a forecast of the accumulated duration of the already transmitted locating signals 5 and the locating signal 5 to be transmitted. If the accumulated duration of the already transmitted locating signals 5 and the locating signal 5 to be transmitted would exceed the threshold value 16, a transmission of the locating signal 5 to be transmitted can be blocked by the monitoring unit 9. Otherwise, the planned transmission can be enabled by the monitoring unit 9 and the time-stamp signal 14 with the duration of the locating signal 5 to be transmitted can be stored in the buffer memory.

The circuit apparatus 2 offers advantages over the prior art. There is no need to use configuration rules due to the use of the monitoring unit 9.

The application does not need to consider worst-case scenarios when the circuit apparatus 2 is configured. This eliminates complex configuration rules and dynamic configuration changes. It is possible to use threshold value configurations that are excluded due to worst-case considerations but are very unlikely to involve non-standard seconds. The duty-cycle limiter/the monitoring unit 9 would guarantee accurate compliance with regulatory requirements, while sporadic blocking of the emission of locating signals 5 would not noticeably affect the performance of the circuit apparatus 2 in locating sessions.

The performance of the core functionalities is maintained by assigning respective priority values 13 to the locating signals 5. The inclusion of priority management in the duty-cycle limiter allows the use of configurations that result in a significant amount of packet losses, for example, from locating signals 5 for UWB time synchronization or final data distribution via UWB, while maintaining core functionality without loss of performance. Packet loss can be understood to mean the monitoring unit 9 blocking a transmission of the locating signal 5 to be transmitted.

No code variations are required for different protocols. Through implementation in a lower layer of a software stack, higher layers can use the same code as is used even in an application in circuit apparatuses 2 without a monitoring unit 9. There is no need to distinguish between use cases with and without duty-cycle limiters, except for whether the duty-cycle limiter is activated or deactivated. This is advantageous for worldwide use because the predetermined transmission condition 10 is region-specific and is not required for all regions of the world.

Proven compliance is drawn upon. In Europe, radio approval is usually carried out by means of a manufacturer's declaration. The manufacturer must be able to demonstrate here compliance with the regulations based on measurements or design measures. The technical function “duty-cycle limiter” enables the verification of compliance with regulations under worst-case conditions, which can also be checked in a measuring structure. It is possible to use a configuration that would obviously result in a severe non-conforming switched-on duration but the corresponding circuit apparatus 2 would still be conforming due to the duty cycle limiter. This eliminates the need to investigate worst-case scenarios as part of a risk assessment.

Overall, the example shows how the use of the monitoring unit can ensure compliance with a maximum utilization level for the frequency band.

### LIST OF REFERENCE DESIGNATIONS

1 Vehicle
2 Circuit apparatus
3 Control unit
4 Device unit
5 Locating signal
6 Transceiver unit
7 Control signal
8 Transmission conditions
9 Monitoring unit
10 Transmission criterion
13 Priority value
14 Time-stamp signal
15 Priority
16 Threshold value
T1 First time interval
T2 Second time interval
S1-S3 Locating sessions

1. A circuit apparatus for locating at least one device unit in a respective locating session, wherein the circuit apparatus and the at least one device unit communicate with one another via ultra-wide-band radio, UWB, in a predetermined common frequency band,
wherein the circuit apparatus comprises a control unit configured to control a transceiver unit of the circuit apparatus to emit a respective locating signal to a respective device unit in successive time blocks of a predetermined time grid of the locating session,
wherein the circuit apparatus comprises a monitoring unit configured to check, before a respective transmission of a locating signal to be transmitted, whether a predetermined transmission condition specifying a maximum permissible degree of utilization for the frequency band is fulfilled by the transmission of the locating signal to be transmitted, and enable an emission of the locating signal to be transmitted when the transmission condition is fulfilled, and otherwise to block the emission of the locating signal to be transmitted.

2. The circuit apparatus as claimed in claim 1, wherein
the monitoring unit is configured to record a number of transmitted locating signals in a predetermined first time interval, and
the transmission condition comprises a transmission criterion which specifies that the transmission of the locating signal currently to be transmitted is enabled only when a permissible maximum number of transmissions of locating signals is undershot when the locating signal to be transmitted is transmitted in the first predetermined time interval.

3. The circuit apparatus as claimed in claim 1, wherein
the monitoring unit is configured to record an accumulated duration of pulse times of the already transmitted locating signals in a predetermined second time interval, and
the transmission condition comprises a transmission criterion which specifies that the transmission of the locating signal to be transmitted is enabled only when a permissible maximum accumulated duration of the locating signals is undershot when the locating signal to be transmitted is transmitted in the second predetermined time interval.

4. The circuit apparatus as claimed claim 2,
wherein
the transmission criterion depends on a priority value of the locating signal to be transmitted.

5. The circuit apparatus as claimed in claim 2,
wherein
the monitoring unit is configured to determine a time-stamp signal, which signals a reception time of a respective transmitted locating signal by the device unit, and is configured to record only those transmitted locating signals whose time-stamp signal is present.

6. The circuit apparatus as claimed in claim 2,
wherein
the transmission criterion depends on a number of currently simultaneously running locating sessions.

7. The circuit apparatus as claimed in claim 2,
wherein
the respective time intervals are at least one of timer-based, monitored based on at least one of a sliding window algorithm and a ring buffer.

8. The circuit apparatus as claimed in claim 1,
wherein
the time grid is set based on a random function or a pseudo-random function.

9. The circuit apparatus as claimed in claim 1,
wherein
the monitoring unit is configured to reserve, after at least one blocking, a priority for locating signals to that device unit for which the transmission of the locating signal was blocked, and to take the reservation into account when checking the transmission condition.

10. A method for operating a circuit apparatus for locating at least one device unit in a respective locating session, wherein the circuit apparatus and the at least one device unit with one another via ultra-wide-band radio, UWB, in a predetermined common frequency band,
wherein a control unit of the circuit apparatus is used to control a transceiver unit of the circuit apparatus to emit a respective locating signal to the respective device unit in successive time blocks of a predetermined time grid of the locating session,
wherein a monitoring unit of the circuit apparatus is used to check, before a respective transmission of a locating signal to be transmitted, whether a predetermined transmission condition used to specify a maximum degree of utilization for the frequency band is fulfilled by the transmission of the locating signal to be transmitted,
wherein an emission of the locating signal to be transmitted is enabled by the monitoring unit when the transmission condition is fulfilled, and otherwise the emission of the locating signal to be transmitted is blocked by the monitoring unit.

11. A vehicle, comprising a circuit apparatus as claimed in one of claim 1.
